(19) United States
(12) Patent Application Publication
(10) Pub. No.: US 2020/0109357 A1
(43) Pub. Date: Apr. 9, 2020

(54) USE OF A CLEAN COMPOSITION FOR 3D-PRINTED ARTICLES AND RELATED PROCESS

(71) Applicant: 3M INNOVATIVE PROPERTIES COMPANY, St. Paul, MN (US)

(72) Inventors: Michael Jahns, Gilching (DE); Anja Friedrich, München (DE); Malte Korten, Moorenweis (DE); Gioacchino Raia, Türkenfeld (DE); Adrian S. Eckert, Herrsching (DE); Gallus Schechner, Herrsching (DE); Arno Schmalzl, Woerthsee (DE)

(21) Appl. No.: 16/616,638

(22) PCT Filed: May 17, 2018
(86) PCT No.: PCT/US2018/033073

§ 371 Date: Nov. 25, 2019

(30) Foreign Application Priority Data
May 29, 2017 (EP) 17173184.7

(51) Int. Cl. C11D 7/26; C11D 11/00; B29C 64/35; B33Y 40/20; B08B 3/08; B08B 3/10; B08B 3/12

(52) U.S. Cl. CPC C11D 7/266; C11D 11/0035; B29C 64/35; B33Y 40/20; B08B 2220/04; B08B 3/102; B08B 3/12; B08B 2203/007; B08B 3/08

(57) ABSTRACT

The invention relates to the use of a cleaning composition for removing uncured printing resin from 3D-printed articles, the cleaning composition comprising either of the following components alone or in combination: di basic esters of a carboxylic acid, tri basic esters of a carboxylic acid. The invention also relates to a process of cleaning a 3D-printed article, the process comprising the steps of a) providing the cleaning composition and a 3D-printed article comprising uncured printing resin on its surface, b) treating the surface of the 3D-printed article with the cleaning composition, c) optionally treating the 3D article with a solvent, in particular water, d) optionally drying the 3D article, optionally repeating steps b), c) and d) either singly or in combination. A further embodiment of the invention is directed to kit of parts comprising the cleaning composition and a 3D-printable resin composition, as well as a 3D-printing system comprising the cleaning composition, a 3D-printing device and a 3D-printable resin composition.

### FIELD OF THE INVENTION

The invention relates to a cleaning composition for cleaning 3D-printed articles, in particular for 3D-printed articles comprising radiation cured polymers such as cured (meth)acrylate components.

The cleaning composition is in particular useful for removing uncured printing resin from freshly 3D-printed parts made by stereolithography (SLA), such as 3D-printed articles for use in the dental or orthodontic field.

### BACKGROUND ART

The SLA production of 3D-articles involves the layer-wise radiation curing of radiation-curable compositions.

Further, after the radiation curing process is finished, the 3D-printed article has to be removed from the printing vat with the result that on the surface of the obtained 3D-printed article uncured printing resin is present. The uncured resin has to be removed afterwards.

Currently, this cleaning procedure is keeping 3D-printing from being a simple and clean manufacturing procedure, in particular in the dental and orthodontic area.

The current state-of-the-art for cleaning 3D-printed (SLA) parts typically involves the use of iso-propanol with repeated ultrasonic treatment and rinsing.

This method is rather time consuming and, without a fume hood, user and environment are exposed to flammable, organic vapours. Alternative approaches are described in the following documents:

U.S. Pat. No. 5,482,659 (Sauerhofer) describes a method of evacuating uncured resin from internal passages of semi-hollow SLA produced objects. As cleaning solution iso-propanol is suggested.

WO2015070165 A1 (Mosher et al.) relates to a method for removing the support structure from a 3D-printed object using an electrolytic solution.

JP 2011/00566 describes an apparatus for removing a support material from a modelled object formed by a 3D printer using a certain treatment solution. The treatment solution is composed of silicate, phosphate and water.

DE 10 2009 061 069 A1 (Schulz) describes a rinsing composition for removing supporting material from 3D-printed articles. The rinsing composition is an aqueous solution containing 5-15% non-ionic tensides, 5-10% glycol, and up to 5% sodium hydroxide.

The commercially available product Anmasi™ SLA-Cleaner 2000 contains approx. 0-50% water and 50-100% di(ethylene glycol) monobutyl ether, which is a carbitol.

### SUMMARY OF INVENTION

None of the solutions described in the art is completely satisfying. There is still a need for a cleaning composition for cleaning 3D-printed articles which allows a time efficient removal of uncured printing resin from the 3D-printed article, in particular 3D-printed articles obtained by radiation curing a light-curable composition comprising (meth)acrylate component(s) and filler(s).

The cleaning composition should be easy to use and suitable for cleaning in particular small objects like dental and orthodontic articles produced by the dental technician in a so-called chair-side 3D-printing process. Further, the cleaning composition should be non-hazardous.

Ideally, the cleaning composition should also be suitable for conducting a post-curing step of the 3D-printed article, if desired.

This object is achieved by the cleaning composition and kit of parts and related processes described in the present text and claims.

In one embodiment the invention features the use of a cleaning composition for cleaning 3D-printed articles, the cleaning composition comprising either of the following components alone or in combination: di basic esters of a carboxylic acid, tri basic esters of a carboxylic acid.

Alternatively, the cleaning composition is characterized as comprising ester(s) of carboxylic acids having a vapour pressure below 2 hPa at 25° C.

In another embodiment, the invention relates to a process of cleaning a 3D-printed article, the process comprising the steps of:

a) providing the cleaning composition as described in any of the preceding claims and a 3D-printed article,

b) treating the surface of the 3D-printed article with the cleaning composition,

c) optionally treating the 3D article with a solvent, in particular water,

d) optionally drying the 3D article,

optionally repeating steps b), c) and d) either singly or in combination.

A further embodiment of the invention is directed to kit of parts comprising the cleaning composition described in the present text and a 3D-printable resin composition.

The invention is also related to a 3D-printing system comprising the cleaning composition described in the present text, a 3D printing device, and a 3D-printable resin composition comprising (meth)acrylate components.

“Additive manufacturing” or “3d printing” means processes comprising a layer-wise creation of an object from digital data. The articles can be of almost any shape or geometry and are produced from a 3-dimensional model or other electronic data source.

Many 3D printing technologies exist, one of them being vat polymerization which uses a radiation curing step to make 3-dimensional articles.

Examples of vat polymerization techniques include stereolithography (SLA) and digital light processing (DLP) in which successive layers of material are cured by a laser (SLA) and a projector (DLP).

In the present text the term “stereolithographic” and the respective abbreviation SLA are used for all sorts of vat polymerization techniques.

A “hardenable component or material” or “polymerizable component” is any component which can be cured or solidified in the presence of a photo initiator by radiation-induced polymerization. A hardenable component may contain one, two, three or more polymerizable groups. Typical examples of polymerizable groups include unsaturated carbon groups, such as a vinyl group being present i.a. in a (methyl)acrylate group.

A “monomer” is any chemical substance which can be characterized by a chemical formula, bearing polymerizable groups (including (meth)acrylate groups) which can be polymerized to oligomers or polymers thereby increasing the molecular weight. The molecular weight of monomers can usually simply be calculated based on the chemical formula given.

As used herein, “(meth)acryl” is a shorthand term referring to “acryl” and/or “methacryl”. For example, a “(meth) acryloxy” group is a shorthand term referring to either an acryloxy group (i. e., CH₂═CH—C(O)—O—) and/or a methacryloxy group (i. e., CH₂═C(CH₃)—C(O)—O—).

A “curing, hardening or setting reaction” is used interchangeable and refers to a reaction, wherein physical properties such as viscosity and hardness of a composition changes over the time due to a chemical reaction between the individual components.

A “photo initiator” is a substance being able to start or initiate the curing process of a hardenable composition in the presence of radiation, in particular light (wave length from 300 to 700 nm).

The term “dental or orthodontic article” means any article which is to be used in the dental or orthodontic field, especially for producing a dental restoration, orthodontic devices, a tooth model and parts thereof.

Examples of dental articles include crowns, bridges, inlays, onlays, veneers, facings, copings, crown and bridged framework, implants, abutments, dental milling blocks, monolithic dental restorations and parts thereof.

Examples of orthodontic articles include brackets, buccal tubes, cleats and buttons and parts thereof.

A dental or orthodontic article should not contain components which are detrimental to the patient's health and thus free of hazardous and toxic components being able to migrate out of the dental or orthodontic article.

“Ambient conditions” mean the conditions which the composition described in the present text is usually subjected to during storage and handling. Ambient conditions may, for example, be a pressure of 900 to 1100 hPa, a temperature of 10 to 40° C. and a relative humidity of 10 to 100%. In the laboratory ambient conditions are typically adjusted to 20 to 25° C. and 1000 to 1025 hPa.

A composition is “essentially or substantially free of” a certain component, if the composition does not contain said component as an essential feature. Thus, said component is not willfully added to the composition either as such or in combination with other components or ingredient of other components. A composition being essentially free of a certain component usually does not contain that component at all. However, sometimes the presence of a small amount of the said component is not avoidable e.g. due to impurities contained in the raw materials used.

As used herein, “a”, “an”, “the”, “at least one” and “one or more” are used interchangeably. The terms “comprise” or “contain” and variations thereof do not have a limiting meaning where these terms appear in the description and claims. Also herein, the recitations of numerical ranges by endpoints include all numbers subsumed within that range (e.g., 1 to 5 includes 1, 1.5, 2, 2.75, 3, 3.80, 4, 5, etc.).

Adding an “(s)” to a term means that the term should include the singular and plural form. E.g. the term “additive(s)” means one additive and more additives (e.g. 2, 3, 4, etc.).

Unless otherwise indicated, all numbers expressing quantities of ingredients, measurement of physical properties such as described below and so forth used in the specification and claims are to be understood as being modified in all instances by the term “about”. The term “comprise” shall include also the terms “consist essentially of” and “consists of”.

### DETAILED DESCRIPTION

This cleaning composition described in the present text helps to improve the cleaning of 3D-printed articles in particular those obtained by SLA.

The proposed cleaning composition is suitable to simplify and accelerate the cleaning procedure of 3D-printed articles.

It was found that good cleaning results can be achieved, if components are used which are chemically similar to the monomers contained in the printing resin used in the SLA process.

The components used in the cleaning composition described in the present text are non-hazardous substances.

Further, due to their relatively high molecular weight, the components typically have a high boiling point and low vapour pressures. This may enable the use of the cleaning composition even without a fume hood.

It was found that due to a lower vapour pressure, the diesters of carboxylic acids are better suited than the monoesters of carboxylic acids, in particular for cleaning processes conducted between room temperature and 80° C.

Sometimes, it can be desirable to conduct in parallel a thermal post-curing step. Such a thermal treatment typically involves temperatures of 80° C. and above.

The cleaning composition described in the present text is also suitable for conducting such a thermal post-curing step.

For this purpose, triesters of carboxylic acids are suggested as they possess even higher molecular weights and boiling points.

However, due to the higher viscosity of triesters at room temperature, their full cleaning potential is typically achieved at elevated temperatures anyway.

As mentioned above, the components of the cleaning composition described in the present text have a low vapour pressure. Thus, they do not evaporate from the surface of the 3D-printed article after the cleaning step.

Thus, a rinsing step is typically needed to finally remove the cleaning composition from the surface of the 3D-printed article. This can be done with water. Esters are sometimes not fully miscible with water.

If a better miscibility with water is needed or desired, the esters can be mixed with polar solvents having a high boiling point.

The use of carbitols was found to be particular useful in this respect. Carbitols are readily miscible with water and also with esters, working as a moderator between them.

At the same time, carbitols, like the esters, have high boiling points and usually are non-hazardous substances.

The cleaning composition described in the present text is in particular useful for cleaning 3D-printed articles which were produced by processing a filled radiation-curable printing composition in a stereolithographic 3D-printing process.

Filled radiation-curable printing compositions include printing compositions containing (meth)acrylate component(s) and filler(s) in an amount of at least 20 or at least 30 or at least 40 wt. % with respect to the weight of the printing composition.

The cleaning composition is in particular useful for cleaning 3d-printed articles having small dimensions and/or a surface geometry with concave and convex structures and optionally undercuts, like dental articles or orthodontic articles as described above.

The cleaning composition described in the present text contains di basic esters of carboxylic acids, tri basic esters of carboxylic acids or a mixture thereof.

The cleaning composition is for cleaning 3D-printed articles, in particular for 3D-printed articles obtained by radiation curing of (meth)acrylate components containing radiation curable compositions.

The cleaning composition described in the present text can typically be characterized by the following features alone or in combination:
having a pH value from 6 to 8 if brought in contact with wet pH sensitive paper;
being miscible with water up to an amount of 2 parts by weight of water with respect to 1 part by weight of cleaning composition.
   That is, the pH of the cleaning composition is typically in the neutral range.

Further, the cleaning composition is typically not completely soluble in and miscible with water. The cleaning composition is provided as a one-phase system.

The cleaning composition described in the present text comprises carboxylic acid ester(s).

The carboxylic acid ester(s) can typically be described by the following features alone or in combination:

having a boiling point above 150° C. at 1013 hPa;

having a vapour pressure below 2 hPa at 25° C.;

having a molecular weight in the range of 90 to 1,000 g/mol or 100 to 600 g/mol;

having a flash point above 30° C. or above 50° C.

According to one embodiment, suitable di and tri basic carboxylic acid esters are characterized by the following features:
comprising a saturated or unsaturated, branched or linear C₁ to C₁₂ backbone,
comprising two or three carboxylic acid ester moieties attached to the backbone,
wherein the ester moieties are selected from C₁ to C₄ alkyl esters.

The di-basic carboxylic acids of the carboxylic acid esters used in the cleaning composition described in the present text are typically selected from acids characterized by the following formula:

(HOOC)—(CH₂)ₙ—(COOH),

with n being selected from 1 to 12.

In particular, the following di-basic carboxylic acids were found to be useful: propanedionic acid, butanedionic acid, pentanedionic acid, hexandionic acid, heptanedionic acid, octanedioic acid, nonanedionic acid, decanedionic acid and mixtures thereof.

The tri-basic carboxylic acids of the carboxylic acid esters used in the cleaning composition described in the present text are typically selected from citric acid, iso-citric acid, aconitic acid, trimesic acid, propane-1,2,3-tricarboxylic acid and mixtures thereof.

The alcohols of the carboxylic acid esters used in the cleaning composition described in the present text are typically selected from C₁ to C₄ alcohol and mixtures thereof, in particular methanol, ethanol, n-propanol, n-butanol, iso-butanol and mixtures thereof.

Suitable examples of carboxylic acid esters include the methyl and ethyl esters of malonic acid, succinic acid, glutaric acid, adipic acid, citric acid and mixtures thereof.

Using a mixture of di and tri basic carboxylic acid esters can be preferred, to adjust the cleaning properties.

If the cleaning composition comprises a mixture of di and tribasic carboxylic acid esters, the following ration was found to be useful: di basic carboxylic acid ester/tri basic carboxylic acid ester: from 3/1 to 1/3 with respect to weight or from 2/1 to 1/2.

According to one embodiment, the cleaning composition described in the present text comprises the carboxylic acid esters typically in the following amounts: Di basic ester of carboxylic acid: 20 to 100 wt. % or 30 to 100 wt. %, Tri basic ester of carboxylic acid: 0 to 80 wt. % or 0 to 70 wt. %, wt. % with respect to the weight of the whole composition.

The cleaning composition described in the present text may also comprise additive(s).

Suitable additive(s) include solvent(s), in particular solvent(s) having a high boiling point, e.g. a boiling point above 100° C.

In certain embodiments the high boiling additive(s) or solvent(s) can be characterized by at least one or more, sometimes all of the following parameters:
Boiling point: above 100 or above 200 or above 250 or above 300° C.;
Vapour pressure: below 2 hPa or below 1 hPa at 25° C.;
Molecular weight: 100 to 1000 g/mol or 150 to 800 g/mol or 200 to 600 g/mol;
Flash point above 30° C. or above 50° C.

Using a high boiling additive with a boiling point above 100 or above 200 or above 250 or above 300° C. can be beneficial as it may help to improve the post-curing thermal treatment capability of the cleaning composition.

The high boiling solvent is typically a high boiling polar solvent, that is, a high boiling solvent being miscible with water without phase separation.

According to one embodiment, the high boiling solvent is often an alcohol or a glycol or polyglycol, mono-ether glycol or mono-ether polyglycol, di-ether glycol or di-ether polyglycol, ether ester glycol or ether ester polyglycol, carbonate, ester or a polycaprolactone. The organic high boiling point additives usually have one or more polar groups. The organic high boiling point additive does not have a polymerizable group; that is, the organic high boiling point additive is free of a group that can undergo free radical polymerization. Further, no component of the high boiling point additive medium has a polymerizable group that can undergo free radical polymerization.

Suitable glycols or polyglycols, mono-ether glycols or mono-ether polyglycols, di-ether glycols or di-ether polyglycols, and ether ester glycols or ether ester polyglycols are often of the following formula:

R¹O—(R²O)ₙ—R¹

In the above formula each R¹ independently is hydrogen, alkyl, aryl, or acyl. Suitable alkyl groups often have 1 to 10 carbon atoms, 1 to 6 carbon atoms, or 1 to 4 carbon atoms. Suitable aryl groups often have 6 to 10 carbon atoms and are often phenyl or phenyl substituted with an alkyl group having 1 to 4 carbon atoms. Suitable acyl groups are often of formula —(CO)R^{a} where R^{a} is an alkyl having 1 to 10 carbon atoms, 1 to 6 carbon atoms, 1 to 4 carbon atoms, 2 carbon atoms, or 1 carbon atom. The acyl is often an acetyl group (i.e. —C(O)CH₃). In the above formula, each R² is typically an alkylene group such as ethylene or propylene. The variable n is at least 1 and can be in a range of 1 to 10, 1 to 6, 1 to 4, or 1 to 3.

Glycols or polyglycols of the above formula have two R¹ groups equal to hydrogen. Examples of glycols include, but are not limited to, ethylene glycol, propylene glycol, diethylene glycol, dipropylene glycol, triethylene glycol, and tripropylene glycol.

Mono-ether glycols or mono-ether polyglycols of the above formula have a first R¹ group equal to hydrogen and a second R¹ group equal to alkyl or aryl. Examples of mono-ether glycols or mono-ether polyglycols include, but are not limited to, ethylene glycol monohexyl ether, ethylene glycol monophenyl ether, propylene glycol monobutyl ether, diethylene glycol monomethyl ether, diethylene glycol monoethyl ether, diethylene glycol monopropyl ether, diethylene glycol monobutyl ether, diethylene glycol monohexyl ether, dipropylene glycol monomethyl ether, dipropylene glycol monoethyl ether, dipropylene glycol monopropyl ether, triethylene glycol monomethyl ether, triethylene glycol monoethyl ether, triethylene glycol monobutyl ether, tripropylene glycol monomethyl ether, and tripropylene glycol monobutyl ether.

Di-ether glycols or di-ether polyglycols of the above formula have two R1 group equal to alkyl or aryl. Examples of di-ether glycols or di-ether polyglycols include, but are not limited to, ethylene glycol dipropyl ether, ethylene glycol dibutyl ether, dipropylene glycol dibutyl ether, diethylene glycol dimethyl ether, diethylene glycol diethyl ether, triethylene glycol dimethyl ether, tetraethylene glycol dimethyl ether, and pentaethylene glycol dimethyl ether.

Ether ester glycols or ether ester polyglycols of the above formula have a first R1 group equal to an alkyl or aryl and a second R1 group equal to an acyl. Examples of ether ester glycols or ether ester polyglycols include, but are not limited to, ethylene glycol butyl ether acetate, diethylene glycol butyl ether acetate, and diethylene glycol ethyl ether acetate.

Other suitable organic high boiling additives are carbonates of the following formula:

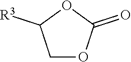

In the above formula, R³ is hydrogen or an alkyl such as an alkyl having 1 to 4 carbon atoms, 1 to 3 carbon atoms, or 1 carbon atom. Examples include ethylene carbonate and propylene carbonate.

Suitable are also polycaprolactones, in particular polycaprolactones having a molecular mass in the range of 200 to 1,000 or from 300 to 800 or 400 to 600 g/mol.

Polycaprolactones are typically the reaction products of caprolactone with diols or triols. Typical examples of diols include ethylene glycol, propylene glycol, butanediol, hexanediol, diethylene glycol. A typical example of a triol includes trimethylolpropane.

Specific examples of high boiling point additives which can be used include: mono alcohols (e.g. C₆ to C₁₂ alcohols, including primary, secondary and tertiary alcohols), poly alcohols (e.g. diethylene glycol ethyl ether (Carbitol™), hexanediol, octanediol, decanediol, dodecanediol), and mixtures thereof.

The following high boiling additives are sometimes preferred: polyethylene glycol, polycaprolactone, diethylene glycol ethyl ether, propylene carbonate and mixtures thereof.

If present the high boiling solvent is typically present in the following amounts:
Lower limit: at least 10 or at least 20 or at least 30 wt. %;
Upper limit: at most 80 or at most 75 or at most 70 wt. %;
Range: 10 to 80 or 20 to 75 or 30 to 70 wt. %;
   wt. % with respect to the weight of the whole composition.

Other additive(s) which can be added are colorant(s).

The addition of colorant(s) to the cleaning composition can make it easier for the practitioner to determine if residues of the cleaning composition are still present on the surface of the treated 3D-printed article or not.

Suitable colorant(s) include organic colorant(s) like food colorants, e.g. Acid Red 18 (E124) or Acid Green 50 (E142) or Beetroot Red (E162) and colorants for non-food applications, e.g. Macrolex™ Violet B or Solvaperm™ Red PFS and mixtures thereof.

According to one embodiment, the cleaning composition comprises:

a di-basic carboxylic acid ester in an amount of 30 to 90 wt. %,

a tri-basic carboxylic acid in an amount of 10 to 40 wt. %,

glycol ether, such as carbitol in an amount of 0 to 40 wt. %,

water in an amount of 0 to 10 wt. %,

wt. % with respect to the weight of the whole composition.

According to another embodiment, the cleaning composition comprises:

a di-basic carboxylic acid ester in an amount of 10 to 50 wt. %,

a tri-basic carboxylic acid in an amount of 0 to 20 wt. %,

glycol ether, such as carbitol in an amount of 30 to 70 wt. %,

water of 0 to 5 wt. %,

wt. % with respect to the weight of the whole composition.

According to another embodiment, the cleaning composition comprises:

a di-basic carboxylic acid in an amount of 0 to 40 wt. %,

a tri-basic carboxylic acid ester in an amount of 30 to 90 wt. %,

glycol ether, such as carbitol in an amount of 0 to 40 wt. %,

water in an amount of 0 to 10 wt. %,

wt. % with respect to the weight of the whole composition.

The cleaning composition described in the present text does typically not contain water in an amount above 10 wt. % or above 5 wt. %.

Further, the cleaning composition described in the present text does typically not contain non-ionic or ionic tenside(s) in an amount above 6 wt. % or above 3 wt. %.

Further, the cleaning composition described in the present text does typically not contain filler(s) in an amount above 1 wt. % or above 0.1 wt. %.

Further, the cleaning composition described in the present text does typically not contain fatty acid salts in an amount above 5 wt. % or 3 wt. % or 1 wt. %.

Unless otherwise stated, the term “wt. %” generally refers to the weight of the whole composition.

The cleaning composition described in the present text can be produced by simply mixing the respective components.

The cleaning composition described in the present text is provided to the practitioner in a suitable packaging devices. Suitable packaging devices include containers, bottles, foil bags and cans.

The volume of the respective packaging devices is not particularly limited, but is typically in a range of 10 to 200,000 ml or 500 to 10,000 ml.

The cleaning composition is typically not provided in form of microcapsules or in encapsulated form.

Described is also a kit of parts comprising the cleaning composition described in the present text and a radiation-curable resin composition, in particular a radiation-curable resin composition comprising (meth)acrylate components for use in an SLA process.

Besides radiation curable components, the radiation-curable resin composition comprises radiation-sensitive initiators, in particular photoinitiators.

Suitable radiation-curable compositions are also commercially available and are also described in the literature, e.g. SHERAprint™-cast or SHERAprint™-model or Prodways PLASTCure™ Cast 200 or Prodways PLASTCure™ Model 300.

The cleaning composition described in the present text is typically provided to the practitioner with an instruction for use.

The instruction for use typically describes under what conditions and how the cleaning composition should and has to be used.

The cleaning composition described in the present text is typically used as follows:

The cleaning composition and a 3D-printed article to be cleaned is provided.

The 3D-printed article is typically an article which has been obtained by a stereolithographic 3D-printing process.

The 3D-printed article typically contains uncured residues of the radiation-curable composition on its surface, which was used for producing the 3D-printed article.

The cleaning composition described in the present text is in particular useful for removing uncured printing resin from 3D-printed articles having convex and/or concave surface elements optionally combined with so-called undercuts like dental and/or orthodontic articles.

The cleaning composition described in the present text is in particular useful for removing residues of radiation curable compositions containing (meth)acrylate components and filler(s).

Filler(s) which might be present include e.g. silica particles in an amount of 5 to 30 wt. %. The silica particles are typically surface-treated, e.g. silanized.

These kind of radiation curable compositions typically have a viscosity in the range of 2 to 100 Pa*s (23° C.) at a shear rate of 10 s⁻¹.

The surface of the 3D-printed article is brought in contact and treated with the cleaning composition.

This is typically done by immersing the 3D-printed article in the cleaning composition. If desired, ultrasound, stirring and/or agitation can be applied.

The treatment step is typically done for a time sufficient for removing the uncured residues. A time period of 1 to 40 min or 2 to 30 min or 2 to 20 min was found to be sufficient.

If desired, the treatment step can be done at elevated temperature, e.g. in a temperature range above 40° C. or above 60° C. but below the boiling point of the cleaning composition.

Further, if desired, the treatment can be done by applying ultrasound and/or stirring.

Further, the treatment can be repeated, if desired, until the uncured residues of the radiation-curable composition is removed.

After the treatment step, the cleaning composition remaining on the surface of the cleaned 3D-printed article is typically removed with a solvent, e.g. water.

The removal of the cleaning composition from the surface of the cleaned 3D-printed article can be improved, if the cleaning composition comprises the polar high boiling solvent(s) outlined above, such as carbitol(s).

If desired, the surface of the cleaned 3D-printed article can be dried afterwards.

A typical process of cleaning a 3D-printed article comprises the following steps

a) providing the cleaning composition as described in the present text and a 3D-printed article comprising uncured printing resin on its surface,

b) treating the surface of the 3D-printed article with the cleaning composition, optionally together with the application of ultrasound, stirring and/or agitation,

c) optionally treating the surface of the 3D-printed article with a solvent, in particular water,

d) optionally drying the 3D-printed article,

optionally repeating steps b), c) and d) either singly or in combination

According to one embodiment, the 3D-printed article is a dental or orthodontic article comprising cured (meth)acrylate components and optionally filler(s).

A typical treatment procedure is as follows:

duration of treatment: 1 to 40 min or 2 to 30 min;

temperature during treatment: 20 to 200° C. or 40 to 180° C.;

optionally application of ultrasound.

If only high boiling components are present in the cleaning composition that have a boiling point above e.g. 100° C., the cleaning composition can also be used for simultaneously conducting a post-curing thermal treatment to the 3D-printed article.

A post-curing thermal treatment is typically conducted at elevated temperature, e.g. above 60° or 70° C. or above 80°, in particular in a temperature range of 60 to 200° C. or 70 to 180° C.

A further aspect of the invention is directed to a 3D-printing system comprising

the cleaning composition described in the present text,

a 3D-printable resin composition comprising (meth)acrylate components,

a 3D printing device, preferably an SLA 3D-printer.

Suitable 3D printing devices are commercially available e.g. from companies such as EnvisionTec, Rapidshape, Prodways and Stratasys.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. The above specification, examples and data provide a description of the manufacture and use of the compositions and methods of the invention. The invention is not limited to the embodiments disclosed herein. One skilled in the art will appreciate that many alternative embodiments of the invention can be made without departing from the spirit and scope thereof.

The following examples are given to illustrate, but not limit, the scope of this invention.

### Examples

Unless otherwise indicated, all parts and percentages are on a weight basis, all water is de-ionized water, and all molecular weights are weight average molecular weight. Moreover, unless otherwise indicated all experiments were conducted at ambient conditions (23° C.; 1013 hPa).

### Materials

TABLE 1

| | |
|---|---|
| di(ethylene glycol) ethyl ether | high boiling polar solvent; carbitol |
| tri(propylene glycol) methyl ether | high boiling polar solvent; carbitol |
| diethyl ester of succinic acid | dibasic carboxylic acid ester |
| diethyl ester of glutaric acid | dibasic carboxylic acid ester |
| diethyl ester of adipic acid | dibasic carboxylic acid ester |
| diethyl ester of | dibasic carboxylic acid ester mixture |
| succinic acid (10-20 wt. %) | |
| diethyl ester of | |
| glutaric acid (55-65 wt. %) | |
| diethyl ester of adipic acid | |
| (15-25 wt. %) | |
| triethyl ester of citric acid | tribasic carboxylic acid ester |
| light curable composition | printing resin |
| containing (meth)acrylate | |
| components and more than | |
| 30 wt. % filler | |
| Printing resin coloured | coloured printing resin |
| with Macrolex ™ | |
| Violet B and | |
| Solvaperm ™ Red PFS | |

### Methods

### Viscosity

If desired, the viscosity can be measured using a Physica Rheometer MCR 301 device with a plate/cone system (diameter 25 mm and angle 1°) and a slit of 0.05 mm. The viscosity values (Pas) can be recorded at 23° C. for each shear rate (starting from 0.1 l/s to 100 l/s in 50 exponential increasing steps). For each shear rate, a delay of 5 s is typically used before collecting data. Also the viscosity values can be recorded at a constant shear of 10 l/s and an increasing temperature ramp (starting at 23° C. to 60° C. in 0.74° C. steps). The above mentioned method of measurement corresponds essentially to DIN 53018-1.

Method for Determining pH-Value

If desired, the measurement of the pH-value can be achieved by means known by the person skilled in art. E.g. the composition can be dispersed in de-ionized water and an instrument like Metrohm™ 826 can be used. Or a wet piece of pH sensitive paper can be brought in contact with the composition.

### Method for Determining Flash Point

If desired, the flash point can be measured according to ISO 1523:2002 using the closed cup equilibrium method.

### Sample Preparation and Cleaning Procedure

3D-printed composite platelets (dimensions: 25 mm×15 mm×1 mm) were made from the printing resin described in the materials section using a S30 3D printer from RapidShape. The platelets were pre-cleaned by immersion in iso-propanol, which was agitated with a magnetic stirrer unit, rinsing with de-ionized water and drying by wiping off the water with a paper cloth.

A drop (100 mg) of coloured printing resin (printing resin with the addition of organic colouring components) was put on a pre-cleaned platelet to obtain a reproducible, clearly visible contamination with printing resin.

The platelet was immersed in 40 ml of the cleaning composition to be tested. The cleaning composition was agitated and pre-heated with a magnetic stirrer unit.

The experimental setup allowed the agitated cleaning composition to pass by the contaminated surface, but the platelet was unable to move and the magnetic stir bar was not able to touch the platelet. The time until the coloured resin was completely removed was measured.

The experiment was performed three times in the same cleaning composition and the cleaning times were averaged.

The colour was added to the printing resin solely to achieve better visibility of the cleaning process. The results are given in Table 2.

### Determination of Water Miscibility:

40 ml of solvent mixture were prepared. Water was added dropwise under stirring, until a second phase started forming, showing that the system was no longer miscible. The amount of water added was recorded.

### Comparative Composition #1 (C.C.1)

iso-propanol (100 wt. %)

### Comparative Composition #2 (C.C.2)—Carbitol Ether

di(ethylene glycol) ethyl ether

### Comparative Composition #3 (C.C.3)—Carbitol Ether

tri(propylene glycol) methyl ether

### Inventive Composition #1 (I.C.1)—Dibasic Ester

mixture of diethyl esters of succinic acid, glutaric acid and adipic acid as described in the materials section

### Inventive Composition #2 (I.C.2)—Tribasic Ester

triethyl ester of citric acid

### Inventive Composition #3 (I.C.3)—Dibasic Ester/Carbitol Ether Mixture

mixture of diethyl esters of succinic acid, glutaric acid and adipic acid as described in the materials section and di(ethylene glycol) ethyl ether; ratio 3:1 by weight

### Inventive Composition #4 (I.C.4)—Dibasic Ester/Carbitol Ether Mixture

mixture of diethyl esters of succinic acid, glutaric acid and adipic acid as described in the materials section and di(ethylene glycol) ethyl ether; ratio 1:1 by weight

### Inventive Composition #5 (I.C.5)—Dibasic Ester/Carbitol Ether Mixture

mixture of diethyl esters of succinic acid, glutaric acid and adipic acid as described in the materials section and di(ethylene glycol) ethyl ether; ratio 1:3 by weight

### Results:

TABLE 2

| | stirrer | | cleaning time | cleaning time |
|---|---|---|---|---|
| | setting | temperature | average/sec | std. dev./sec |
| C.C. 1 | 5 | RT | 3,000 | n.a. |
| C.C. 2 | 5 | RT | 650 | 73 |
| C.C. 2 | 9 | RT | 259 | 41 |
| C.C. 2 | 5 | 79° C. | 73 | 10 |
| C.C. 3 | 5 | RT | 715 | 56 |
| I.C. 1 | 5 | RT | 404 | 69 |
| I.C. 1 | 9 | RT | 136 | 10 |
| I.C. 1 | 5 | 76° C. | 51 | 6 |
| I.C. 2 | 5 | RT | 1,800 | n.a. |
| I.C. 2 | 5 | 82° C. | 82 | 10 |
| I.C. 3 | 5 | RT | 454 | 44 |
| I.C. 4 | 5 | RT | 491 | 69 |
| I.C. 5 | 5 | RT | 562 | 15 |

C.C. = comparative composition;
I.C. = inventive composition

| | water |
|---|---|
| | miscibility/g |
| I.C. 3 | 4.8 |
| I.C. 4 | 25.3 |
| I.C. 5 | 46.2 |

1. Use of a cleaning composition for removing uncured printing resin from a 3D-printed article, the cleaning composition comprising either of the following components alone or in combination:
di basic esters of a carboxylic acid;
tri basic esters of a carboxylic acid.

2. The use according to claim 1, the 3D-printed article comprising cured (meth)acrylate components and optionally fillers.

3. The use according to claim 1, the cleaning composition being characterized by at least one of the following features alone or in combination:
having a pH value from 6 to 8, if brought in contact with wet pH sensitive paper;
being miscible with water up to a ratio of 1 (composition):2 (water) by weight.

4. The use according to claim 1, the esters of carboxylic acid contained in the cleaning composition being characterized by at least one of the following features alone or in combination:
having a boiling point above 150° C. (at 1013 hPa);
having a vapor pressure below 2 hPa at 25° C.;
having a molecular weight in the range of 100 to 600 g/mol;
having a flash point above 30° C.

5. The use according to claim 1, the esters of carboxylic acid being characterized by the following features:
comprising a saturated or unsaturated, branched or linear C₁ to C₁₂ backbone,
comprising two or three carboxylic acid ester moieties attached to the backbone,
wherein the ester moieties are selected from C₁ to C₄ alkyl esters.

6. The use according to claim 1, the esters of carboxylic acid being selected from methyl and ethyl esters of malonic acid, succinic acid, glutaric acid, adipic acid, citric acid and mixtures thereof.

7. The use according to claim 1, comprising in addition either of the following components alone or in combination:
solvent(s) having a boiling point above 100° C.,
solvent(s) having a vapor pressure below 2 hPa at 25° C.

8. The use according to claim 7, the cleaning composition comprising:
ester(s) of carboxylic acid in an amount of 25 to 99.9 wt. %,
solvent(s) having a boiling point above 100° C. in an amount of 0.1 to 75 wt. %,
wt. % with respect to the weight of the whole composition.

9. The use according to claim 7, the cleaning composition comprising:
a di-basic ester of a carboxylic acid in an amount of 25 to 100 wt. %,
a tri-basic ester of a carboxylic acid in an amount of 1 to 25 wt. %,
solvent(s) having a boiling point above 100° C. in an amount of 1 to 75 wt. %,
wt. % with respect to the weight of the whole composition.

10. A process for removing uncured printing resin from a 3D-printed article, the process comprising:
providing the cleaning composition of claim 1 and a 3D-printed article comprising uncured printing resin on its surface,
treating the surface of the 3D-printed article with the cleaning composition,
optionally treating the 3D-printed article with a solvent, in particular water,
optionally drying the 3D-printed article,
optionally repeating the above steps either singly or in combination.

11. The process according to claim 10, the treating step being conducted for a period of 1 to 40 min, optionally by applying ultrasound, stirring and/or agitation.

12. The process according to claim 10, the treating step b) being conducted within a temperature range of 20 to 200° C.

13. The process according to claim 10, the 3D-printed article having the shape of a dental article or orthodontic article.

14. A kit of parts comprising:
the cleaning composition of claim 1; and
a 3D-printable resin composition comprising radiation curable components, preferably (meth)acrylate components.

15. A 3D-printing system comprising:
the cleaning composition of claim 1;
a 3D-printing device; and
a 3D-printable resin composition comprising radiation curable components, preferably (meth)acrylate components.
